(19) United States
(12) Patent Application Publication
(10) Pub. No.: US 2016/0267406 A1
(43) Pub. Date: Sep. 15, 2016

(54) Systems and Methods for Rating Merchants

(71) Applicant: MASTERCARD INTERNATIONAL INCORPORATED, Purchase, NY (US)

(72) Inventors: Loralee Bodo, Hawthorne, NY (US); Adam Granoff, Greenwich, CT (US); Curtis Villars, Chatham, NJ (US); Marianne Iannace, North Salem, NY (US)

(21) Appl. No.: 14/642,745

(22) Filed: Mar. 9, 2015

(51) Int. Cl. G06Q 10/06

(52) U.S. Cl. CPC G06Q 10/0635

(57) ABSTRACT

Systems and methods are provided for rating merchants in different industries, based on transaction data for the merchants and relative to multiple other merchants within same industries as the merchants to be rated. A merchant to be rated is initially identified (e.g., from a request, etc.), along with an industry with which the merchant is associated. Transaction data for the merchant is then accessed from a payment network. The transaction data includes data relating to both payment transactions and chargeback transactions to the merchant over a time interval. Next, a score for the merchant is generated based on at least a number of the chargeback transactions to the merchant during the time interval, and on transaction data for multiple other merchants within the same industry as the merchant. The resulting score is then associated with a risk rating for the merchant, thereby providing an indicator of the merchant's reliability.

### FIELD

The present disclosure generally relates to systems and methods for rating merchants and, more particularly, to rating target ones of the merchants, relative to other merchants within the same industries as the target merchants based on transaction data for transactions performed at the target merchants by consumers.

### BACKGROUND

This section provides background information related to the present disclosure which is not necessarily prior art.

Various entities, for example, the Better Business Bureau, etc., monitor interactions between consumers and merchants, and assign ratings to the merchants based on satisfaction of the consumers with the interactions. Similarly, consumers often provide reviews, comments, feedback, etc. about merchants, and interactions with the merchants, on social media sites such as Yelp®, Twitter®, and Facebook®. Other consumers can then use the ratings as part of deciding whether or not to interact with the merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in rating merchants, relative to other merchants within the same industries as the merchants to be rated based on transaction data associated with the merchants to be rated;

FIG. 2 is a block diagram of a computing device, that may be used in the exemplary system of FIG. 1; and

FIG. 3 is an exemplary method for use in rating a merchant in connection with the system of FIG. 1, relative to other merchants within the same industry as the merchant to be rated based on transaction data associated with the merchant.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Consumers often enter into transactions with merchants to purchase products and/or services. Similarly, service providers (also referred to as customers herein) often enter into transactions with merchants to provide various services to the merchants. In some cases, however, the merchants may be in distress or may be untrustworthy, or may be unable or unwilling to complete the transactions (e.g., unable or unwilling to provide the products and/or services to the consumers, unable or unwilling to complete payment for the services provided by the service providers, etc.). As can be appreciated, entering into transactions with unreliable merchants can result in loss to the consumers and/or the service providers. Thus, it is desirable to know, prior to initiating such transactions, whether or not the merchants pose risks. The systems and methods described herein associate ratings (e.g., risk ratings, reliability ratings, etc.) with the merchants, thereby indicating to the consumers and/or the service providers which of the merchants are reliable and/or which of the merchants may pose such risks.

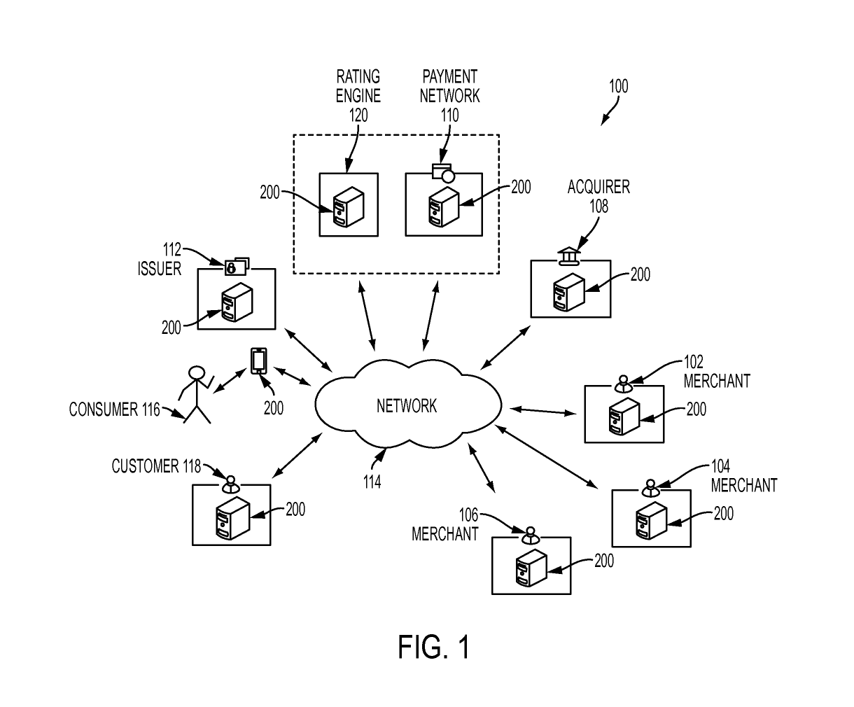

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components in the exemplary embodiments, processing of payment transactions in the exemplary embodiments, etc.

As shown in FIG. 1, the illustrated system 100 generally includes multiple merchants 102, 104, and 106, an acquirer 108, a payment network 110, and an issuer 112, each coupled to network 114. The merchants 102, 104, and 106 may include online merchants, having virtual locations on the Internet (e.g., websites accessible through the network 114, etc.), to permit consumers (e.g., consumer 116) to initiate transactions for products and/or services offered by the merchants 102, 104, and 106 through their websites, etc. In addition, one or more of the merchants 102, 104, and 106 may also include at least one brick-and-mortar location. Further, in various aspects, customers (e.g., customer 118) may interact with the merchants 102, 104, and 106 to provide various desired services to the merchants 102, 104, and 106 (e.g., advertising services, shipping services, etc.). Or, customers (e.g., customer 118) may include, for example, rating providers (e.g., rating websites, etc.) or other entities that compile ratings for multiple merchants (e.g., including merchants 102, 104, and 106, etc.) and then use the ratings to compare the merchants (e.g., list the top fifty merchants for each industry, etc.), or review the merchants, or otherwise provide information about the merchants, etc.

The network 114 of the system 100 may include, without limitation, a wired and/or wireless network, a local area network (LAN), a wide area network (WAN) (e.g., the Internet, etc.), a mobile network, a virtual network, and/or another suitable public and/or private network capable of supporting communication among two or more of the illustrated components of the system 100, or any combination thereof. In one example, the network 114 includes multiple networks, where different ones of the multiple networks are accessible to different ones of the illustrated components in FIG. 1.

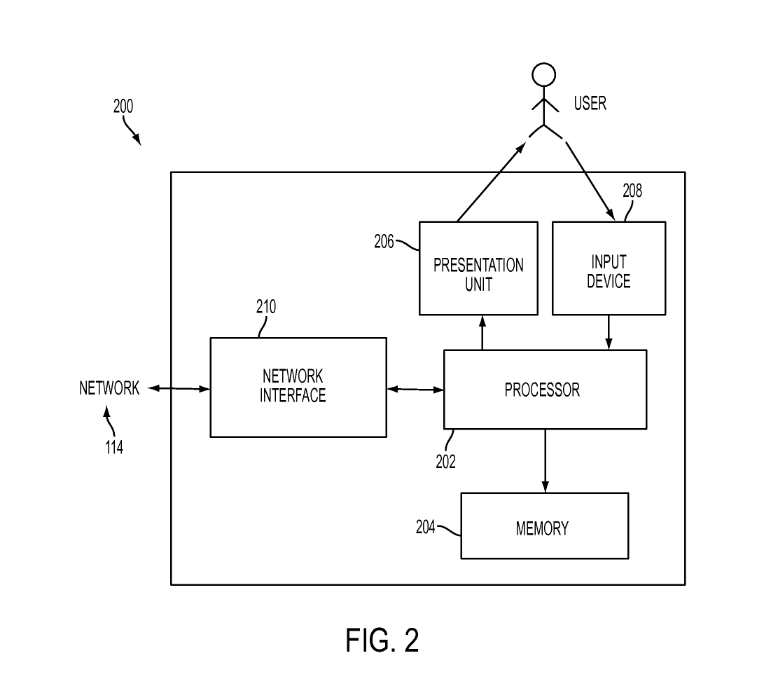

In addition, each of the merchants 102, 104, and 106, the acquirer 108, the payment network 110, the issuer 112, the consumer 116, and the customer 118 in the system 100 is associated with, or implemented in, one or more computing devices. For illustration, the system 100 is described with reference to exemplary computing device 200, illustrated in FIG. 2. And, each of the merchants 102, 104, and 106, the acquirer 108, the payment network 110, the issuer 112, the consumer 116, and the customer 118 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 114, or separate therefrom.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, requests to rate the merchants 102, 104, and 106 (or other merchants), transaction data, listings of merchant category codes (MCCs) and their associated market segments, variables to be used in generating scores for the merchants 102, 104, and 106 (or for other merchants), scores generated for the merchants 102, 104, and 106 (or for other merchants), rating scales, ratings assigned to the merchants 102, 104, and 106 (or to other merchants), and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 116; the customer 118; individuals associated with one or more of the merchants 102, 104, and 106, the acquirer 108, the payment network 110, the issuer 112, or rating engine 120 in the system 100; etc.) by, for example, displaying, audibilizing, and/or otherwise outputting information such as, but not limited to, information relating to the merchants 102, 104, and 106 (e.g., products and/or services for sale, etc.), requests to rate the merchants 102, 104, and 106, transaction data associated with the consumer 116 and/or the merchants 102, 104, and 106, merchant scores, merchant ratings, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 114. In some exemplary embodiments, the computing device 200 includes the processor 202 and one or more network interfaces incorporated into or with the processor 202.

By way of example (and without limitation), the exemplary computing device 200 may include one or more servers, personal computers, laptops, tablets, PDAs, telephones (e.g., cellular phones, smartphones, other phones, etc.), point of sale (POS) terminals, combinations thereof, etc. as appropriate.

Referring again to FIG. 1, in general, the merchants 102, 104, and 106 offer various products and/or services for sale to the consumer 116. When desired, the consumer 116 can then use a payment account, provided by the issuer 112, to purchase desired ones of the products and/or services. However, in order to process these purchase transactions, the merchants 102, 104, and 106 must initially enroll with the payment network 110 (e.g., through the acquirer 108, etc.) which then coordinates approval, settlement, etc. for the transactions. In so doing, the payment network 110 collects various details from the merchants 102, 104, and 106 (e.g., organization addresses, types of products and/or services to be provided, etc.), and stores the details in memory 204 of the payment network computing device 200.

With that said, typically in the system 100, one of the merchants 102, 104, and 106 (merchant 102 in the following description), along with the acquirer 108, the payment network 110, and the issuer 112, cooperate, in response to a request from the consumer 116, to complete a payment transaction for a product and/or service using the consumer's payment account. As part of the payment transaction, the consumer 116 initially provides information (e.g., a payment account number (PAN), etc.) about the payment account to the merchant 102 via a payment card, another payment device (e.g., a fob, a smartphone, etc.), or via login credentials for a previously established purchase account (e.g., an electronic wallet such as MasterPass™, Google Wallet™, PayPass™, Softcard®, etc.), etc. The merchant 102 reads the payment account information and communicates, via the network 114, an authorization request to the payment network 110, via the acquirer 108 (associated with the merchant 102), to process the transaction (e.g., using the MasterCard® interchange, etc.). The authorization request includes various details of the transaction (e.g., transaction data, etc.) to help facilitate processing the authorization request. The payment network 110, in turn, communicates the authorization request to the issuer 112 (associated with the consumer's payment account). The issuer 112 then provides an authorization response (e.g., authorizing or declining the request) to the payment network 110, which is provided back through the acquirer 108 to the merchant 102. The transaction with the consumer 116 is then completed, or not, by the merchant 102, depending on the authorization response.

Also in the system 100, the consumer 116 may initiate a chargeback transaction to one of the merchants 102, 104, and 106 (again merchant 102 in the following description) for one or more reasons (e.g., the consumer 116 did not receive the purchased product or service from the merchant 102, or believes the received product or service is defective or damaged; the consumer 116 does not recognize, or did not make, a payment transaction with the merchant 102 processed to his/her payment account, or was a victim of fraud; etc.). In so doing, for example, the consumer 116 initially interacts with the issuer 112 to initiate a request (or claim) for the chargeback transaction (e.g., provides payment account details to the issuer 112, details of the reason for making the chargeback transaction request, etc.). When the issuer 112 determines that the chargeback transaction is appropriate (e.g., proper, valid, warranted, etc.), the issuer 112 interacts with the acquirer 108, via the payment network 110, to obtain credit for the amount in dispute (and provides a temporary credit for the appropriate amount to the consumer's payment account). Then, when the acquirer 108 determines that the chargeback transaction is appropriate, the acquirer 108 removes the disputed amount from the merchant's account (such that the merchant 102 suffers the loss), and reconciles as needed with the issuer 112.

For both the payment transaction and the chargeback transaction described above, transaction data is generated as part of the interactions among the merchant 102, the acquirer 108, the payment network 110, the issuer 112, and the consumer 116. Depending on the transaction, the transaction data is transmitted from the merchant 102 to the issuer 112 through the payment network 110 or otherwise (e.g., as part of the authorization request, as part of the chargeback request, etc.). The transaction data may include, without limitation, an indication of whether the transaction is a payment transaction or a chargeback transaction, the PAN for the consumer's payment account involved in the transaction, a payment amount for the product(s) and/or service(s) involved in the transaction, identifier(s) for the product(s) and/or service(s) involved in the transaction, description(s) of the product(s) and/or service(s) involved in the transaction, a listing of product(s) and/or service(s) involved in the transaction, a merchant name for the merchant 102 involved in the transaction, a merchant identification number (MID) for the merchant 102, a MCC assigned to the merchant 102 (e.g., by the payment network 110 or by another payment network 110, based on a type of products and/or services provided by the merchant 102, etc.), a date and/or time of the transaction, a location of the transaction, etc.

Other payment transactions and chargeback transactions in the system 100, involving one or more of the consumer 116, the merchant 102, the other merchants 104 and 106, or other consumers and/or merchants accommodated by the system 100 but not shown, are also processed in similar manners to the above example transactions between the consumer 116 and the merchant 102. Transaction data is also generated in connection with these transactions.

Once generated, the transaction data (either as part of a payment transaction or a chargeback transaction) is stored in one or more different components of the system 100. In the illustrated embodiment, for example, the payment network 110 collects the transaction data and stores it in memory 204 of the payment network 110 computing device 200 (e.g., in a data structure associated with the memory 204, etc.). As such, the payment network 110 includes, in the memory 204 of the computing device 200, a compilation of consumers and merchants involved in the various transactions processed by the payment network 110, and the corresponding transaction data for the transactions. Further, the transaction data can be stored by the payment network 110, in the memory 204 of the computing device 200, in various different manners, for example, according to one or more of the payment account used by the consumer 116, the merchant(s) involved in the transaction (e.g., the MID for the merchant involved, the MCC for the merchant involved, etc.), or any other criteria, such that the transaction data is readily usable as described herein. It should be appreciated that the same or different transaction data may be collected and stored within other components of the system 100. In addition, while the transaction data is described as stored in the memory 204 of the payment network 110 computing device 200, it should be appreciated that the transaction data could be stored apart from the memory 204 (e.g., in data structures associated with the payment network 110 but apart from the computing device 200, etc.) in various implementations.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc. to use data collected during enrollment and/or collected in connection with processing the transactions, subsequently for one or more of the different purposes described herein (e.g., for use in rating the merchants, etc.).

With continued reference to FIG. 1, the illustrated system 100 also includes a rating engine 120 associated with (e.g., implemented in, etc.) a computing device 200. The rating engine 120 is configured, often by computer-readable instructions, to, among other functions described herein, associate ratings (e.g., risk ratings, reliability ratings, etc.) with the merchants 102, 104, and 106 (or with other merchants not shown, but supported by the system 100) based, in part, on transaction data for transactions made at the merchants 102, 104, and 106. The ratings then provide indicators to consumers (e.g., the consumer 116, etc.) and/or customers (e.g., the customer 118, etc.) of the merchants' reliability (e.g., the likelihood that the merchants 102, 104, and 106 will continue in business in the future, the likelihood that the merchants 102, 104, and 106 are not fraudulent, etc.), and can be used by the consumers and/or the customers in deciding whether or not to interact with the merchants 102, 104, and 106, or in comparing different ones of the merchants 102, 104, and 106. In the illustrated system 100, the rating engine 120 is a stand-alone entity. However, it is contemplated that the rating engine 120 could be associated with (or incorporated into) the payment network 110 in some implementations (as indicated by the broken lines in FIG. 1). Alternatively, in other embodiments, the rating engine 120 may be incorporated into other entities shown in the system 100 (e.g., the issuer 112, etc.), or not shown.

In the system 100, the rating engine 120 receives one or more requests, via the network 114 or otherwise, to rate the merchants 102, 104, and 106 (also referred to as target merchants). Each of the requests may identify one of the merchants 102, 104, and 106 to rate, or a single one of the requests may identify all of the merchants 102, 104, and 106. In addition, the requests may originate directly from the merchants 102, 104, and 106 to be rated, or they may originate from customers (e.g., the customer 118, etc.) that are currently associated with the merchants 102, 104, and 106 or that are investigating whether or not to become associated with the merchants 102, 104, and 106, or that are desirous to compare the merchants 102, 104, and 106 to each other or to other merchants in similar industries. When the requests originate from the merchants 102, 104, and 106, for example, the merchants 102, 104, and 106 may use the ratings in advertisements to consumers (e.g., the consumer 116, etc.) in order to solicit business. When the requests originate from the customers, the customers may then use the ratings in advertisements to the consumers on behalf of the merchants 102, 104, and 106 (e.g., to highlight certain ones of the merchants 102, 104, and 106 with higher ratings as trusted merchants, etc.), or they may use the ratings to help determine with which of the merchants 102, 104, and 106 to associate (e.g., as trusted merchants, etc.), to help inhibit dealings with potentially unreliable ones of the merchants 102, 104, and 106, to help inhibit participation with the certain ones of the merchants 102, 104, and 106 in potentially fraudulent activities, to compare the merchants 102, 104, and 106 to each other or to other merchants in similar industries, etc. The customers may include, without limitation, online shopping providers of aggregated merchant sales listings (e.g., Amazon™, Google™, Etsy™, eBay™, etc.), manufacturers, shipping entities, rating entities, ranking entities, review entities, etc.

Once the requests are received, the rating engine 120 categorizes each of the merchants 102, 104, and 106 by their industry. In the system 100, this is based on the MCC for each of the merchants 102, 104, and 106 and a country of organization for each of the merchants 102, 104, and 106 (e.g., a country in which each of the merchants 102, 104, and 106 is registered, a country in which each of the merchants 102, 104, and 106 conducts business, a country in which each of the merchants 102, 104, and 106 is located, etc.). For example, in the system 100, the merchant 102 may be categorized as a grocery store (MCC 5411) in the US, the merchant 104 may be categorized as an electronics merchant (MCC 5732) in China, and the merchant 106 may be categorized as a restaurant (MCC 5814) in the US. In other embodiments, merchants may be categorized based on other data, for example, standard industrial classifications (SICs) of the merchants, regions of organization of the merchants, business tenure, data usage compliant metrics about transaction behavior (e.g. average ticket size band, etc.), etc.

The rating engine 120 also accesses transaction data for each of the merchants 102, 104, and 106 from the requests. The accessed transaction data may include the transaction data collected and stored by the payment network 110 (as described above) and/or it may include transaction data collected and stored by one or more other payment networks, as desired.

Next, the rating engine 120 generates a score for each of the merchants 102, 104, and 106 using the accessed transaction data, and associates the score to a rating (and assigns the ratings to appropriate merchants 102, 104, and 106). The association is based on a relationship of the score to one or more predefined scores (or ranges of scores) on a rating scale, where each of the predefined scores represents a different rating. As an example, the rating engine 120 may generate a score for the merchant 102 of 90 (normalized to a scale of 0-100). The various predefined scores on the applicable rating scale may then include four ranges of scores, each associated with a particular rating: 0-20 (zero star rating), 21-50 (one star rating), 51-80 (two star rating), 81-100 (three star rating). In this example, the rating for the merchant 102 then is three stars.

In some implementations, the scores generated for the merchants 102, 104, and 106 by the rating engine 120 may be weighted based on the particular industries of the merchants 102, 104, and 106. The weighting (e.g., application of industry factors, etc.) can be determined as desired, for example, based on empirical transaction data for the merchant and/or other merchants in the same industries (e.g., data related to other merchants in the same industries that are/were in distress (e.g., that filed for bankruptcy, that went out of business, etc.) and/or that are/were untrustworthy (e.g., that were unable or unwilling to complete transactions, etc.), as well as data related to merchants in the same industries that are/were not in distress and/or that are/were trustworthy, etc.), such that inherent risks or other unique features of the industries are captured in the scores. What's more, through this weighting, merchants in different industries but with the same (or similar) transaction data will not necessarily have the same (or similar) scores. In other implementations, the scores generated for the merchants 102, 104, and 106 may be generic for all industries (i.e., not weighted) and, thus, based solely on transaction data for the merchants 102, 104, and 106. Here, merchants in different industries but with the same (or similar) transaction data may have the same (or similar) scores.

In addition, in some implementations, the predefined scores used in connection with associating the scores to the ratings are unique to the industries of the merchants 102, 104, and 106 being rated (e.g., again based on industry factors, etc.). The predefined scores can also be determined as desired, for example, based on empirical transaction data for other merchants in the same industries (e.g., as described above, etc.), such that inherent risks or other unique features of the industries are again captured. As such, merchants in different industries but with the same (or similar) scores will not necessarily have the same (or similar) ratings. In other implementations, however, the predefined scores may be generic for all industries, such that the resulting ratings for the merchants 102, 104, and 106 are dictated solely by the scores generated for the merchants 102, 104, and 106.

After the ratings are assigned to the appropriate merchants 102, 104, and 106, the rating engine 120 stores the ratings in the memory 204 of the rating engine 120 computing device 200, and then publishes the ratings as desired. For example, in connection with publishing the ratings, the rating engine 120 may communicate, via the network 114, the ratings back to the merchants 102, 104, and 106 and/or customers, from where the requests originated. The merchants 102, 104, and 106 and/or customers can then use the rating as desired (e.g., as described herein, or in other manners).

In this manner, the rating engine 120 can associate ratings with multiple different merchants in multiple different industries, without limitation. In addition, in various implementations of the system 100, the resulting ratings for the merchants 102, 104, and 106 are industry specific, taking into account transaction data for the merchants 102, 104, and 106 to be rated, as well as transaction data for other merchants in the same industries as the merchants 102, 104, and 106 to be rated.

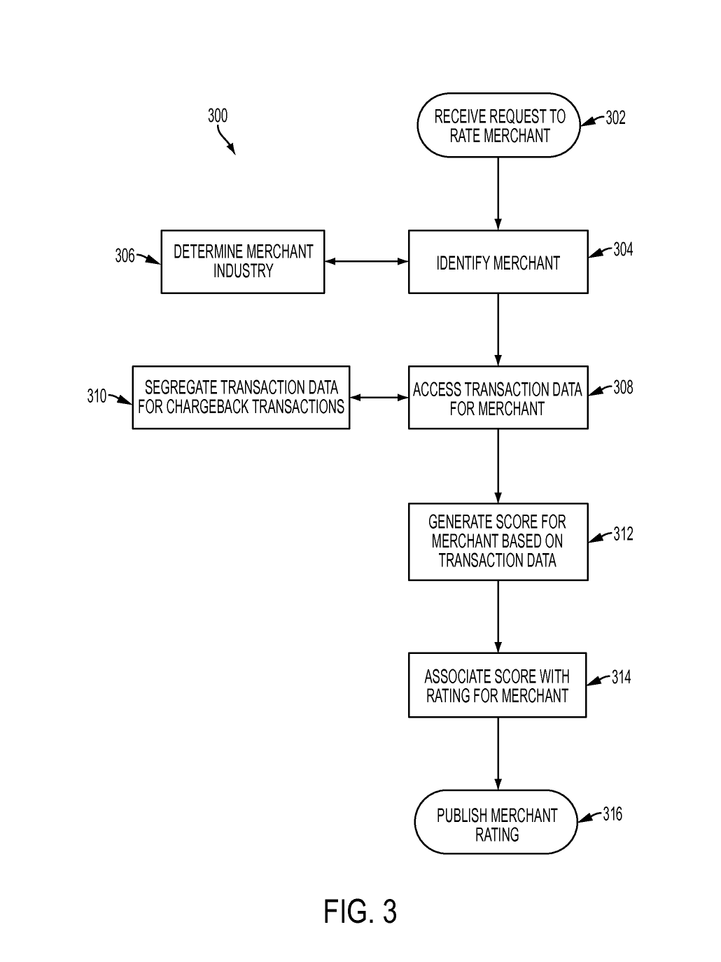

FIG. 3 illustrates exemplary method 300 for use in rating a merchant, relative to other merchants within the same industry and based on transaction data associated with the merchant. The exemplary method 300 is described as implemented in the rating engine 120 of the system 100, with further reference to the merchant 102, the acquirer 108, the payment network 110, the issuer 112, and the customer 118. However, the method 300 could be implemented in one or more other entities, in other embodiments. Further, for purposes of illustration, the exemplary method 300 is described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the illustrated method 300, the rating engine 120 initially receives, at 302, a request to associate a rating (e.g., a risk rating, a reliability rating, etc.) with the merchant 102 (e.g., the target merchant, etc.). The request is received by the rating engine 120 at the computing device 200, via network 114, and is stored in memory 204. As described in connection with the system 100, the request may originate directly from the merchant 102 (e.g., from computing device 200, etc.), or the request may originate from the customer 118 (e.g., from computing device 200, etc.). In addition, the request can include any desired data related to the merchant 102 (e.g., as required by the rating engine 120, etc.) such as, for example, an identification of the merchant 102 (e.g., a name of the merchant 102, etc.) and the MCC assigned to the merchant 102, etc. While the method 300 is described in connection with rating the merchant 102, it should be appreciated that it could equally apply to rating the other merchants 104 and 106 in the system 100, or to rating any other merchants.

Once the request is received, the rating engine 120 (e.g., the processor 202 associated with the rating engine 120, etc.) identifies, at 304, from the request, the merchant 102. As part of this operation, the rating engine 120 also determines, at 306, an industry with which the merchant 102 is associated. The merchant's industry, as used in the method 300, includes the market segment associated with the MCC assigned to the merchant 102, and a country of organization for the merchant 102 (however, this particular combination is not required for a merchant's industry in other embodiments). Thus, in the method 300, for example, the rating engine 120 may determine the industry for the merchant 102 as a grocery store in the US. With that said, the MCC for the merchant 102 will typically be included in the request, or will be available from the payment network 110 (e.g., via a request, etc.). As such, the market segment associated with the MCC can then be determined, for example, using a master list of MCCs stored in the memory 204 of the rating engine 120 computing device 200, etc. Similarly, the country of organization for the merchant 102 will typically be included in the request, or will be available from the payment network 110.

After identifying the merchant 102, the rating engine 120 accesses transaction data for the merchant 102, at 308. As described in connection with the system 100, this may include accessing the transaction data from the payment network 110 (e.g., via network 114, etc.), and/or accessing it from one or more other payment networks. In the method 300, the rating engine 120 accesses the transaction data from the payment network 110, for all transactions taking place at the merchant 102 over a predefined interval (e.g., the last month, the last three months, the last six months, the last year, the last two years, etc.). The accessed transaction data includes data associated with all types of transactions involving the merchant 102, including both payment transactions and chargeback transactions. The data for chargeback transactions is then segregated by the rating engine 120, at 310, from the data for payment transactions (and, in some embodiments, both are retrieved from the payment network 110 and stored separately in the memory 204 of the rating engine 120 computing device 200).

Next, the rating engine 120 generates a score for the merchant 102 at 312. The score is then normalized, for example, to a scale of 0-100, to facilitate further processing. And, the score is stored in the memory 204 of the rating engine 120 computing device 200, as desired.

The score may be generated by aggregating individual values for one or more variables related to the merchant 102 and to the transaction data for the merchant 102. The multiple variables can include any desired variables such as, for example, those related to the merchant's industry and/or those related to the merchant's transaction data. Example variables include, without limitation, a first transaction index for the merchant 102 calculated, in days, as 365 days minus a number of days since a first transaction in the accessed transaction data; a chargeback index (or ratio) calculated as a ratio of a number of chargeback transactions to the merchant 102 for a particular interval (e.g., a one month interval, a two month interval, a three month interval, a six month interval, etc.) to a number of payment transactions for the same particular interval; a 1-3 chargeback index calculated as a ratio of a number of chargeback transactions to the merchant 102 for the last month to a number of chargeback transactions for the last three months; a 3-6 chargeback index calculated as a ratio of a number of chargeback transactions to the merchant 102 for the last three months to a number of chargeback transactions for the last six months; a 6-6 chargeback index calculated as a ratio of a number of chargeback transactions to the merchant 102 for the last six months to a number of chargeback transactions for the same six months one year prior; etc. The particular variables used in generating the score for the merchant 102, in the method 300, are selected based on the industry of the merchant 102, for example, using the empirical transaction data for other merchants in the same industry. In addition, in some implementations, the selected variables may then be weighted, again based on the industry of the merchant 102 (e.g., using the empirical transaction data for other merchants in the same industry, etc.).

With continued reference to FIG. 3, at 314, the rating engine 120 associates the generated score for the merchant 102 with a rating. And, the rating is then assigned to the merchant 102, for example, in the memory 204 of the rating engine computing device 200, etc. The resulting rating may include any suitable rating such as, for example, a numerical value (e.g., on a scale from 0-3, 0-5, 0-10, etc.), a graphical image (e.g., one star, two stars, three starts, a thumb up, a thump down, etc.), a color association (e.g., a red highlight for a low rating, a yellow highlight for a middle rating, a green highlight for a high rating, etc.), combinations thereof, etc.

In particular, in the method 300 the appropriate rating for the merchant 102 is determined by comparing the merchant's score to a group of predefined scores on a rating scale, where each of the predefined scores represents a different rating. In this embodiment, the predefined scores are unique to the industry of the merchant 102, and are determined based on the empirical transaction data for other merchants in the same industry. The appropriate rating is then assigned to the merchant 102 based on where the merchant's score falls on the rating scale. In other embodiments, however, it should again be appreciated that the predefined scores may be generic for all industries.

As an example, the chargeback index may be used, alone, to generate the score of the merchant 102 (however, in other embodiments, one or more other, additional, or different variables may be used). As such, the rating engine 120 determines a total number of payment transactions for the merchant 102 over a desired interval, within the predefined interval for which the transaction data for the merchant 102 was originally accessed (e.g., from the segregated payment transactions, etc.). The rating engine 120 then also determines a total number of chargeback transactions (or chargebacks) over the same desired interval (e.g., from the segregated chargeback transactions, etc.). The score is then determined, in this example, as the ratio of the number of chargebacks for the interval to the number of payment transactions for the same interval. This value may then, in some aspects, be weighted, as desired (e.g., as previously described herein), and/or normalized to a scale of 0-100. And, the resulting score is then associated with an appropriate rating (e.g., based on a relationship of the score to one or more predefined scores (or ranges of scores) on a rating scale, where each of the predefined scores represents a different rating, etc.). As can be appreciated, additional variables can be added to the calculation, and weighted as desired, to ultimately determine the score and rating.

As another example, the rating engine 120 may apply the following exemplary algorithm, or regression model, to generate scores for various merchants:

Y=β₀+β₁x₁+β₂x₂+ . . . +βₙxₙ+ε (1)

where the variables in the algorithm (1) are as follows:

Y=merchant score;

β₀=intercept representing statistical value for a particular industry based on the empirical data for the industry (as described herein) and/or the merchant location (e.g., a country of organization for the merchant, etc.) taking into account the empirical data, etc.;

x₁=first independent variable used in connection with generating the merchant score;

β₁=coefficient (or weighting) applied to first independent variable x₁;

x₂=second independent variable used in connection with generating the merchant score;

β₂=coefficient (or weighting) applied to second independent variable x₂;

xₙ=n^{th} independent variable used in connection with generating the merchant score;

βₙ=coefficient (or weighting) applied to n^{th} independent variable xₙ; and

ε=standard representation of error, to help reduce (or minimize) differences between the actual value and the mean.

In one application of the algorithm (1), the rating engine 120 generates a score for each of the merchant 102 and the merchant 104 using the following five variables: a first transaction index (calculated as described above), a chargeback index (calculated as described above), a 1-3 chargeback index (calculated as described above), a 3-6 chargeback index (calculated as described above), and a 6-6 chargeback index (calculated as described above). The values of each of the variables are also normalized by the rating engine 120, in this application, to a scale of 1-100. The resulting score for each of the merchants 102 and 104 is then calculated by the rating engine 120 by summing the scores for each of the five individual variables. As shown in Table 1, the resulting score for the merchant 102, in this example, is 361.5. And, as shown in Table 2, the resulting score for the merchant 104 is 1500.

TABLE 1

| | Variable (x) | Coefficient (β) | Variable Value | Score |
|---|---|---|---|---|
| 1 | First Transaction Index | 3 | 50 | 150 |
| 2 | Chargeback Index | 3 | 23 | 69 |
| 3 | 1-3 Chargeback Index | 2 | 45 | 90 |
| 4 | 3-6 Chargeback Index | 1.5 | 20 | 30 |
| 5 | 6-6 Chargeback Index | 1.5 | 15 | 22.5 |
| | | | | 361.5 |

TABLE 2

| | Variable (x) | Coefficient (β) | Variable Value | Score |
|---|---|---|---|---|
| 1 | First Transaction Index | 5 | 75 | 375 |
| 2 | Chargeback Index | 6 | 35 | 210 |
| 3 | 1-3 Chargeback Index | 8 | 50 | 400 |
| 4 | 3-6 Chargeback Index | 7 | 45 | 315 |
| 5 | 6-6 Chargeback Index | 5 | 40 | 200 |
| | | | | 1500 |

As described above, in this application, the values of each of the variables are normalized by the rating engine 120 to a scale of 1-100. This is done, for example, by stack ranking the values for each of the variables against each other, for merchants in the same corresponding industries as the merchants 102 and 104, and then assigning the values a number from 1-100 (or, it could be 0-99, as desired) so that essentially 100 stack-ranked buckets exist. In so doing, a value of 1 represents the top 1% of all values and a value of 100 represents the bottom 1% of all values. With that said, it should be appreciated that the rating engine 120 may perform similar operations to normalize the resulting scores of the merchants 102 and 104, for example, by stack ranking the scores against scores for other merchants in the same corresponding industries, and then assigning the scores a number from 1-100.

As can be seen, the coefficients used in the algorithm (1) for the merchant 102 (Table 1) are lower than those used for the merchant 104 (Table 2). As previously discussed, these coefficients provide a weighting to the scores for the merchants 102 and 104 based on their industry using, for example, empirical transaction data for other merchants in the same industry, etc. As such, the coefficients capture different risks, etc. in the different industries with which the merchants 102 and 104 are associated. And, through the resulting algorithm (that includes the various coefficients), a relative comparison of each of the merchants 102 and 104 to other merchants in the same industries can be made. In addition, different thresholds may therefore also be set for different industries.

Then in this application, for each of the merchants 102 and 104, the rating engine 120 associates the resulting score with an appropriate rating (e.g., based on a relationship of the score to one or more predefined scores (or ranges of scores) on a rating scale, where each of the predefined scores represents a different rating, etc.).

In one aspect of this application, in associating the merchants' scores with appropriate ratings, the rating engine 120 may determine how the merchants' scores compare to scores for other merchants in the same corresponding industries as the merchants 102 and 104. For both merchants 102 and 104 in this aspect, a very poor rating is based upon a relative rank of 1-10, a poor rating is based on a relative rank of 11-20, an acceptable rating is based on a relative rank of 21-30, a good rating is based on a relative rank of 31-40, a very good rating is based on a relative rank of 41-50, and an excellent rating is based on a relative rank of greater than 51. As such, if the score for the merchant 102 (i.e., the score of 361.5) is within the bottom twenty-five percent (i.e., a max rank of 1-25) for the merchant's industry, the merchant 102 would be deemed acceptable. And, if the score for the merchant 104 (i.e., the score of 1500) is within the bottom ten percent (i.e., a max rank of 1-10) for the merchant's industry, the merchant 104 would be deemed very poor.

In another aspect of this application, in associating the merchants' scores with appropriate ratings, the rating engine 120 may again determine how the merchants' scores compare to scores for other merchants in the same corresponding industries. Here, however, the relative rankings of the merchants may be different for different industries, for example, based on different weightings for the different industries (again using empirical data for the different industries, etc.). With that in mind, in this aspect, for merchant 102, a very poor rating is based upon a relative rank of 1-20, a poor rating is based on a relative rank of 21-40, an acceptable rating is based on a relative rank of 41-60, a good rating is based on a relative rank of 61-80, a very good rating is based on a relative rank of 81-90, and an excellent rating is based on a relative rank of greater than 91. But for merchant 104, a very poor rating is again based upon a relative rank of 1-10, a poor rating is based on a relative rank of 11-20, an acceptable rating is based on a relative rank of 21-30, a good rating is based on a relative rank of 31-40, a very good rating is based on a relative rank of 41-50, and an excellent rating is based on a relative rank of greater than 51. Thus, if the score for the merchant 102 (i.e., the score of 361.5) is within the bottom twenty-five percent (i.e., a max rank of 1-25) for the merchant's industry, the merchant 102 would be deemed poor in this aspect. And, if the score for the merchant 104 (i.e., the score of 1500) is within the bottom ten percent (i.e., a max rank of 1-10) for the merchant's industry, the merchant 104 would again be deemed very poor.

In another application of the algorithm (1), the rating engine 120 again generates a score for each of the merchant 102 and the merchant 104 using the following five variables (as described above in connection with the prior application): a first transaction index, a chargeback index, a 1-3 chargeback index, a 3-6 chargeback index, and a 6-6 chargeback index. And, the values of each of the variables are also normalized by the rating engine 120 to a scale of 1-100. The resulting score for each of the merchants 102 and 104 is then calculated by the rating engine 120 by summing the scores for each of the five individual variables. As shown in Table 3, the resulting score for merchant 102, in this application, is 557.5. And, as shown in Table 4, the resulting score for merchant 104 is 1500.

TABLE 3

| | Variable (x) | Coefficient (β) | Variable Value | Score |
|---|---|---|---|---|
| 1 | First Transaction Index | 3 | 75 | 225 |
| 2 | Chargeback Index | 3 | 35 | 105 |
| 3 | 1-3 Chargeback Index | 2 | 50 | 100 |
| 4 | 3-6 Chargeback Index | 1.5 | 45 | 67.5 |
| 5 | 6-6 Chargeback Index | 1.5 | 40 | 60 |
| | | | | 557.5 |

TABLE 4

| | Variable (x) | Coefficient (β) | Variable Value | Score |
|---|---|---|---|---|
| 1 | First Transaction Index | 5 | 75 | 375 |
| 2 | Chargeback Index | 6 | 35 | 210 |
| 3 | 1-3 Chargeback Index | 8 | 50 | 400 |
| 4 | 3-6 Chargeback Index | 7 | 45 | 315 |
| 5 | 6-6 Chargeback Index | 5 | 40 | 200 |
| | | | | 1500 |

In this application, the variable values for the merchant 102 (see Table 3) are the same as for the merchant 104 (Table 4). However, different coefficients are used for the merchants 102 and 104, to account for the merchants 102 and 104 being in different industries. As such, in this application, the rating engine generates a score for the merchant 102 of 557.5, versus a score of 1500 for the merchant 104. Further, in associating each of the scores with appropriate ratings in this application, a very poor rating is based upon a relative merchant rank of 1-10, a poor rating is based on a relative merchant rank of 11-20, an acceptable rating is based on a relative merchant rank of 21-30, a good rating is based on a relative merchant rank of 31-40, a very good rating is based on a relative merchant rank of 41-50, and an excellent rating is based on a relative merchant rank of greater than 51. Thus, if the score for the merchant 102 (i.e., the score of 557.5) is within the bottom fifteen percent (i.e., a max rank of 1-15) for the merchant's industry, the merchant 102 would be deemed poor. And, if the score for the merchant 104 (i.e., the score of 1500) is within the bottom ten percent (i.e., a max rank of 1-10) for the merchant's industry, the merchant 104 would be deemed very poor.

With reference again to FIG. 3, finally in the method 300, the rating engine 120 stores the rating in the memory 204 of the rating engine 120 computing device 200, and then publishes the rating at 316 as desired. For example, in connection with publishing the rating, the rating engine 120 may communicate, via the network 114, the rating back to the merchant 102 and/or customer 118, from where the request originated. And, the merchant 102 and/or customer 118 can then use the rating as desired (e.g., as described herein, or in other manners, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request to rate a merchant; (b) identifying the merchant to be rated and an industry with which the merchant is associated; (c) accessing, from a payment network, transaction data associated with the merchant, where the transaction data includes chargebacks to the merchant during a predefined interval; (d) generating a score for the merchant, where the score is based on at least the chargebacks to the merchant during the predefined interval and transaction data for multiple other merchants within the same industry as the merchant; (e) associating the score to a risk rating for the merchant, thereby providing an indicator of the merchants' reliability; and (f) publishing the risk rating for the merchant.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in rating a merchant, based on transaction data for the merchant and relative to multiple other merchants within a same industry as the merchant, the method comprising:
identifying, at a computing device, a merchant to be rated and an industry with which the merchant is associated;
accessing, from a payment network, transaction data associated with the merchant, the transaction data including chargebacks to the merchant during a predefined interval;
generating, at the computing device, a score for the merchant, the score based on at least the chargebacks to the merchant during the predefined interval and transaction data for multiple other merchants within the same industry as the merchant;
associating the score, at the computing device, to a risk rating for the merchant, thereby providing an indicator of the merchant's reliability; and
publishing, at the computing device, the risk rating for the merchant.

2. The method of claim 1, wherein generating the score for the merchant includes weighting the chargebacks to the merchant based on the industry of the merchant.

3. The method of claim 1, wherein associating the score to the rating for the merchant includes:
comparing the score to at least one predefined score; and
assigning the rating based on the comparison.

4. The method of claim 3, further comprising generating the at least one predefined score, based on the transaction data for the multiple other merchants.

5. The method of claim 1, wherein generating the score for the merchant includes generating the score for the merchant based on at least a ratio of chargebacks to the merchant during multiple intervals within the predefined interval.

6. The method of claim 5, wherein the multiple intervals within the predefined interval include a first interval, and a second interval longer than the first interval; and
wherein the ratio of chargebacks includes a ratio of a total number of chargebacks during the first interval and total number of chargebacks during the second interval.

7. The method of claim 6, wherein the first interval and the second interval at least partially overlap.

8. The method of claim 5, wherein the ratio of chargebacks includes a ratio of chargebacks during the same interval.

9. The method of claim 1, wherein generating the score for the merchant includes generating the score for the merchant based on at least a ratio of chargebacks to the merchant and payment transactions to the merchant within the predefined interval.

10. The method of claim 1, further comprising receiving, at the computing device, a request to rate the merchant, from a customer associated with the merchant;
wherein identifying the merchant is based on the received request; and
wherein publishing the risk rating for the merchant includes transmitting the risk rating to the customer.

11. The method of claim 1, wherein the risk rating for the merchant is selected from the group consisting of a numerical value and graphical image.

12. A system for use in rating merchants in different industries, based on transaction data for the merchants and relative to multiple other merchants within the same industries as the merchants to be rated, the system comprising:
a data structure configured to store transaction data for merchants, the transaction data including payment transactions to the merchants and chargeback transactions to the merchants; and
at least one processor coupled to the data structure, the at least one processor configured to:
generate a score for a first merchant, based on a number of chargebacks to the first merchant during a predefined interval and based on an industry for the first merchant;
generate a score for a second merchant, based on a number of chargebacks to the second merchant during the predefined interval and based on an industry for the second merchant, the industry for the second merchant different from the industry for the first merchant;
associate the score for the first merchant to a rating for the first merchant; and
associate the score for the second merchant to a rating for the second merchant;
whereby the rating for the first merchant is different from the rating for the second merchant, even when the number of chargebacks to the first merchant is the same as the number of chargebacks to the second merchant.

13. The system of claim 12, wherein the at least one processor is further configured to:
assign a first weight to the number of chargebacks to the first merchant based on the industry for the first merchant, in connection with generating the score for the first merchant; and
assign a second weight, different from the first weight, to the number of chargebacks to the second merchant based on the industry for the second merchant, in connection with generating the score for the second merchant.

14. The system of claim 12, wherein the at least one processor is further configured to:
compare the score for the first merchant to a first rating scale and determine the rating for the first merchant based on the comparison; and
compare the score for the second merchant to a second rating scale and determine the rating of the second merchant based on the comparison.

15. The system of claim 14, wherein the first rating scale is the same as the second rating scale.

16. The system of claim 14, wherein the at least one processor is further configured to:
generate the first rating scale, based on transaction data for multiple merchants in the same industry as the first merchant; and
generate the second rating scale, based on transaction data for multiple merchants in the same industry as the second merchant, the second rating scale being different from the first rating scale.

17. A non-transitory computer readable media including executable instructions which, when executed by at least one processor, cause the at least one processor to:
identify a merchant to be rated and an industry with which the merchant is associated;
access transaction data for the merchant from a payment network, the transaction data including payment transactions and chargeback transactions to the merchant during a predefined interval;
generate a score for the merchant, based on a number of chargeback transactions during the predefined interval and based on the industry for the merchant;
associate the score for the merchant to a risk rating for the merchant, thereby providing an indicator of the merchant's reliability; and
publish the risk rating for the merchant.

18. The non-transitory computer readable media of claim 17, wherein the computer executable instruction, when executed by the at least on processor, further cause the at least one processor to:
assign a weight to the number of chargeback transactions to the merchant during the predefined interval, based on the industry for the merchant, in connection with generating the score for the merchant.

19. The non-transitory computer readable media of claim 17, wherein the computer executable instruction, when executed by the at least on processor, further cause the at least one processor to compare the score for the merchant to a rating scale and determine the rating for the merchant based on the comparison.

20. The non-transitory computer readable media of claim 17, wherein the computer executable instruction, when executed by the at least on processor, further cause the at least one processor to generate the rating scale, based on transaction data for multiple merchants in the same industry as the merchant.
